(19) United States
(12) Patent Application Publication
(10) Pub. No.: US 2004/0204966 A1
(43) Pub. Date: Oct. 14, 2004

(54) Method and system for providing a combination of life insurance coupled with customer services through time of need

(76) Inventors: Mark W. Duffey, Houston, TX (US); Michael S. Lade, Houston, TX (US); Boris Brizeli, Toronto (CA); Rick Spiering, Toronto (CA)

Correspondence Address: AKIN, GUMP, STRAUSS, HAUER & FELD, 1111 LOUISIANA STREET, 44TH FLOOR, HOUSTON, TX, 77002, US

(21) Appl. No.: 10/410,087

(22) Filed: Apr. 9, 2003

(51) Int. Cl. G06F 17/60

(52) U.S. Cl. 705/4

(57) ABSTRACT

A unique approach to the funeral industry includes the packaging of life insurance with customer services to be continuously provided from the time of enrollment through time of need. This invention includes a central services provider that makes continuously available to a customer who has obtained life insurance consultation services for the purpose of arranging with a customer a funeral plan. The customer services provider provides internet access to a website or other internet-based address to provide for electronic enrollment both for insurance and funeral planning. Such internet access or website is linked to competitive pricing databases and/or customer satisfaction databases, which are electronically available through the website or otherwise to customer members. Funeral plans are stored in an electronic data vault and made available upon need, with the central services provider providing consultation to the customer's family at the time of need to finalize a funeral plan for implementation at a particular funeral home. The system of this invention includes an internet access site coupled to databases containing information on life insurance and information on competitively priced funeral products and services offered independently of association with any particular funeral home.

### CROSS-REFERENCE TO RELATED APPLICATIONS

Not Applicable.

### STATEMENTS REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

This invention relates to the advanced funeral planning industry.

2. Description of the Related Art

Advanced funeral planning is the purchase of funeral expenses in advance of death. The funeral services industry in the U.S. is comprised of about 22,000 providers with only about 15% of the industry consolidated. For the most part, grieving families or customers interested in pre-arranging a funeral look to funeral homes near them. The U.S. Federal Trade Commission mandates that funeral providers must disclose in writing the prices for their services on an à-la-carte basis and such information must be for public review; however, funeral homes typically carry products from a limited number of funeral merchandise providers with whom the funeral homes have business arrangements. The average cost of a funeral today is about $5,400, but additional related costs such as burial, memorialization, and other expenses bring the average cost of death-related expenses to about $10,000.

Various surveys have shown that a large percentage of people, as much as 84%, believe it is better to pre-arrange one's own funeral than not to pre-arrange. Surveys have also shown that consumers distrust the funeral profession because, among other reasons, funeral homes are not perceived as providing fair and effective services, thus taking advantage of the distressed family.

Currently, the insurance component of the advanced funeral planning market has two segments: “final expense” and “pre-need.” The “final expense” segment is distributed principally through insurance companies and is only a mechanism to pre-fund estimated final expenses. Final expense insurance policies provide the consumer with the benefit of discounted, age-based pricing of insurance, but at least typically, no advanced planning service is provided. The insurance agent may send out to the customer a planning guide for the customer to fill out and retain, but this planning guide is often ignored. Upon need, the insurance becomes available but, most likely, the family must make most decisions as to funeral products and arrangements at that time.

The “pre-need” insurance segment is distributed almost exclusively through funeral homes or through multiple location funeral home networks and provides a combination of pre-planning and pre-funding. But pre-need insurance is expensive, typically priced on a dollar-for-dollar basis, or higher, because there is no age-based pricing at attractive rates. Typically, a sales representative or funeral home representative meets with the customer to plan the funeral, including choice of funeral products sold by that funeral home so that the funeral plan is substantially completed. Once the plan is priced, the customer will fund into a trust account or purchase an insurance contract.

Funeral planning is also available to the public without having to meet with funeral home representatives. For example, Forethought Funeral Planning has an interactive website which allows a user to complete a funeral plan, and at the same time offers a user pre-need insurance. The website describes two agreements that are made when a customer purchases insurance coverage: one agreement between the customer and Forethought Life Insurance Co. and a funeral planning agreement between the customer and the funeral home. Other websites are available to entice pre-planners, but most such websites, including Forethought's own website, are dependent upon the participation of specific funeral homes who must be willing to make their prices available on-line. To date, such websites have not been particularly successful because many funeral homes are reluctant to publish their prices or otherwise participate.

### SUMMARY OF THE INVENTION

In order to overcome the disadvantages with currently known types of life insurance and available planning for funerals, the inventors have devised a new and unique business system for providing a package of life insurance and on-going customer services from the time of interest in funeral planning through finalization of funeral arrangements. This business system includes formation of a central business entity or other organization having contractual arrangements with one or more providers of life insurance. However, there are no specific contracts with funeral homes so that the central business entity can provide consumer oriented funeral planning and implementation services. The central business entity includes a website for electronically answering potential customer inquiries and a customer relations group electronically coupled to the website to provide additional answers and clarification to a potential customer. The website further includes an enrollment module to allow a customer to actually enroll in an insurance plan on the website. Further, the website is electronically coupled to one or more providers of life insurance to allow the customer to directly enroll with an insurer. The customer relations group further includes a call service center for communicating with a customer who has just obtained a life insurance contract in order to consult with that customer to develop a personalized funeral plan. The central business entity further includes an electronic data vault to receive and store personalized funeral plans. And, upon need, the customer relations group, which is electronically coupled to said data vault, retrieves the personalized funeral plan, and consults with the customer's representatives to finalize funeral product pricing and services into a finalized funeral plan which is implemented at a designated funeral home. The system of this invention further includes a competitive pricing database of funeral products and/or services which database is electronically connected to the website as well as to the customer relations group. A further electronic database containing historical customer survey information is also electronically connected to the website as well as to the customer relations group so that a customer can obtain the experience of prior customers with respect to products and services.

In addition to the business system of this invention, this invention provides a method of providing services and products in a package of life insurance, funeral planning and implementation of a funeral plan at time of need. A central organization or business entity is created to organize and supervise a combination of life insurance and customer services which are to be made available from the time a customer exhibits interest in life insurance through the actual time of need. A website is provided to receive inquiries from potential customers and to direct those customers to a member services section, which includes a funeral planning module to allow a customer to plan his or her own funeral with or without the additional services provided by a customer services group. The methodology of this invention further includes making contractual arrangements with one or more life insurance providers who provide a fee to the central business entity upon payment by the customer of insurance premiums. The central organization further provides a website which is coupled to an electronic platform of one or more designated insurance carriers to allow potential customers direct access to electronic information relating to such insurance carriers. The central organization further includes a continuously available customer services group which is activated with respect to a new customer upon that customer's obtainment of life insurance and thereafter provides the customer or the customer's representatives with services and information relating to planning a funeral and implementation of a funeral plan at time of need. The website further provides a customer access to an electronic database of funeral homes and funeral products which are maintained by said database on a competitive basis such that a customer may have available to it information from multiple providers of products and services. The customer services group includes as part of its business methodology providing funeral planning services to a customer newly enrolled in a life insurance plan and thereafter providing a completed funeral plan, or partially completed plan, to an electronic database or vault, which is available to the customer prior to the time of need for purposes of retrieval or revision. The customer services group retrieves the electronically stored plan from the data vault at the time of need and thereafter consults with the customer's family or representatives to finalize a funeral plan, including making available competitive pricing on products and services, and thereafter contacting the chosen funeral home to assist the representatives in making actual funeral arrangements.

The business system and methodology of this invention may apply beyond the funeral industry into other analogous industries where services are funded with insurance but provided at a future time. For example, this invention applies to the long-term care and critical illness industries. Such similar concepts are within the scope of the invention, which may include any combination of the above recited steps or system components which provide the advantages of this invention.

### BRIEF DESCRIPTION OF THE DRAWINGS

FIG. 1 is a schematic of the interrelationship of services, insurance and other products with computerized systems to provide the funeral product/services method and system of this invention;

FIG. 2 is a flowchart of the initial steps of customer marketing and enrollment in the funeral product/services method and system of this invention;

FIGS. 3 and 3B combine to form a flowchart of the interrelationship of personal computer and/or web-based services provided to assist a customer who has obtained life insurance to prepare a funeral plan;

FIGS. 4A, 4B, and 4C are flowcharts of initial services provided to a customer's family at time of need, including advising on the purchase of funeral products and services as well as choice of funeral home to the extent such decisions have not been made;

FIG. 5 is a schematic view of certain of the computer hardware and software of this invention; and

FIG. 6 is a schematic of the application of this invention to other industries such as long-term care or critical illness care industries.

### DESCRIPTION OF THE PREFERRED EMBODIMENT

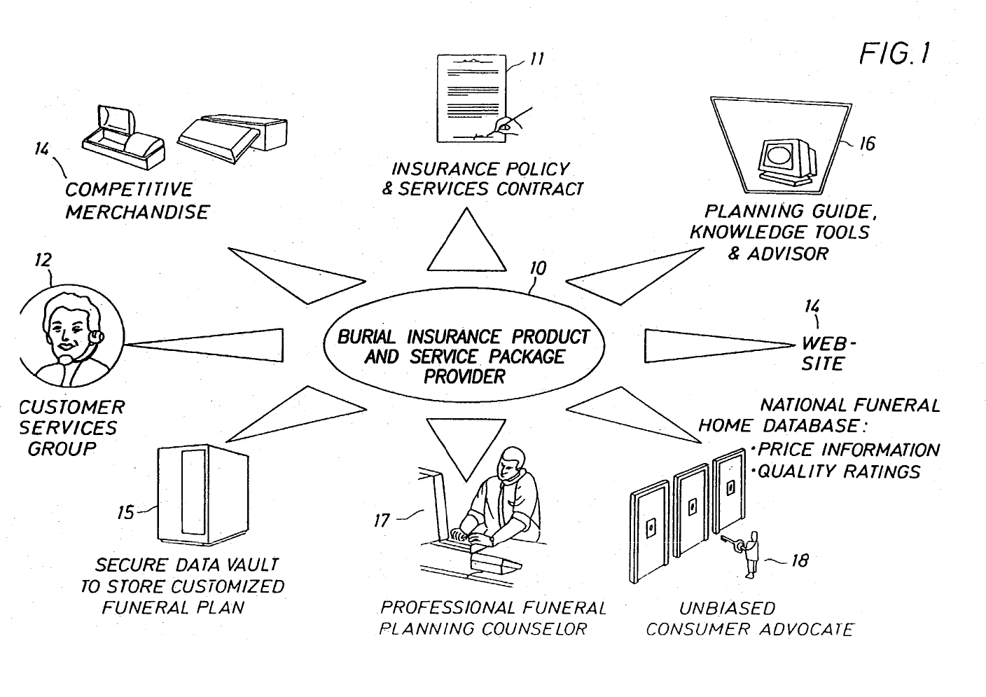

Referring to the drawings and in particular to FIG. 1, the business methodology and system of this invention is illustrated. At the center of this the novel business method and system is the life insurance product and service package provider generally designated as 10. In essence, the life insurance product/service provider or “IP/SP”, which will be hereinafter termed the “package provider” or IP/SP, is a business entity which has organized the method and business system of this invention. The package provider has contracted with one or more insurance providers to provide to customers an insurance policy and services contract 11. This insurance policy and services contract is the result of negotiations between the package provider and one or more insurance carriers in order to make available to potential customers reasonably priced life insurance which will offer rates based upon the typical parameters used in pricing life insurance. In addition, the package provider can create a separate services contract to be signed between the customer and the package provider when the insurance contract is signed, or the package provider can include within the insurance policy certain obligations of the package provider to provide the continuous services of this invention. The package provider further includes a customer services group 12 which may be characterized as a “concierge” service to be available at all times and continuously through the time of need. The customer services group includes a call center which is available to potential customers during the period in which a potential customer is determining whether or not to purchase a life insurance policy, and if a life insurance policy is purchased, the customer services group 12 will provide continuous services to such customer from the time or signature upon the insurance policy contract through the time of need. The package provider is not associated with any funeral home, and does not require funeral homes to make contractual arrangements with the package provider at any time. It is the intent of the package provider through its customer services group and in combination with the other features of this invention to make available to customers competitive pricing with respect to funeral home products or merchandise and not to restrictively carry only certain brands of products, as is typical with funeral homes. The package provider further includes an operating website 14 or other internet or network access to provide to actual or potential customers information relating to life insurance and a panoply of services provided to a customer who has purchased a life insurance policy. The website includes interconnection through internet links or other electronic coupling to one or more insurance policy provider electronic platforms 25 so that a potential customer can obtain either from the website or directly from the electronic platform of an insurance provider, or such insurance provider's website, information relating to schedules and fees for life insurance. An electronic database generally designated as 14 is provided to make available to customers competitive prices on an entire range of funeral products and services. Such database 14 for competitive merchandise is electronically stored and available through a separate website, or network or is a module within the main website of the service provider. Additionally, an electronic database of funeral homes and funeral home related services is also provided, which includes price information as well as quality ratings, which is also electronically coupled to the website 14 or functions as a module or routine on the website 14.

A secure data vault 15 is also provided in the form of an electronic database storage facility or server system 15 which is coupled to the website 14 as well as to the customer services group 12 in order to provide access by the customer to the customer services group 12 to prepare a funeral plan for a new customer member who has obtained life insurance. The customer services group or IP/SP 12 further provides planning guide materials and knowledge tools as well as actual consulting advice relating to funeral planning as part of rendered services. Additionally, the customer services group includes one or more professional funeral planning counselors capable of consulting with customers who have recently signed up for life insurance in order to help those customers to prepare an initial funeral plan, which is then electronically forwarded from the computer files of the customer services group (generally designated at 17) to the secure data vault 15. The customer services group 12 functions as an unbiased consumer advocate, as generally designated at 18, to provide to customers the availability of funeral products and services from a variety of manufacturers so that customers have a full range in choice without regard to a particular funeral home.

### Marketing Phase

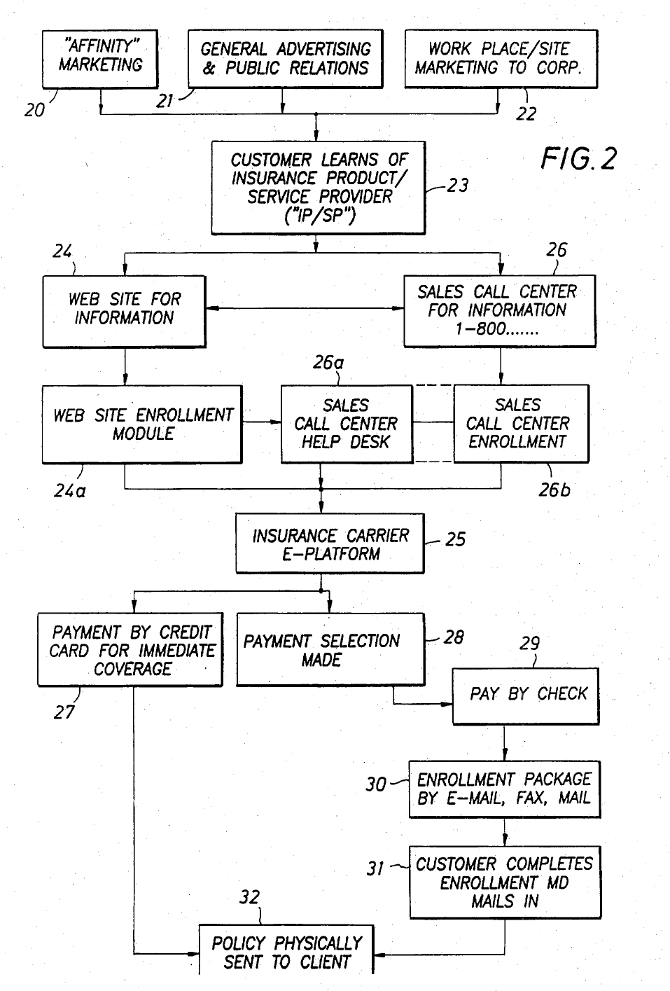

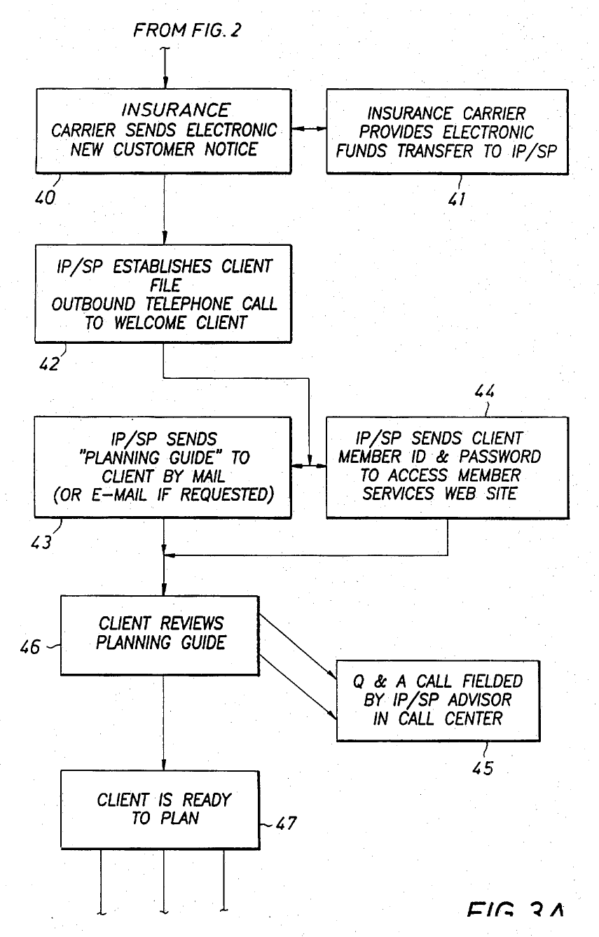

Referring to FIG. 2 of the drawings, the combined products and services of this invention is marketed in a number of ways. “Affinity” marketing identified at 20 is one preferred marketing approach because of the service offering features as part of the funeral products/services of this invention. It is anticipated that the customer services group 12 will have a marketing division or team which will partner with other organizations that have a relationship with consumers within targeted demographics to advertise the products and services of this invention. General advertising and public relations campaigns as indicated at 21 will be a further source of customers, as will work place marketing directly to corporations, which is designated at 22. The IP/SP is the hub product service organizer and provider which has contractual and other relationships with the components 12-18 as identified in FIG. 1.

Once the customer learns of the insurance product/service provider, which event is designated at block 23, the customer can choose to access through his or her computer website 24 and proceed to access the website enrollment module 24a, which is a software module that is available within the website 24. In lieu of a website, other equivalent internet or network access is provided. The website enrollment software module 24a is directed to enrollment by a potential customer into a life insurance program in order to obtain a life insurance policy and services contract 11 as illustrated in FIG. 1. Should the potential customer need additional information, the website enrollment module 24a and/or website 24 itself is coupled to the insurance carrier E-platform 25 so that a link can direct a potential customer to the actual electronic platform or network access site of the insurance carrier. One of the advantages of this invention is that the central organization or IP/SP 10 has negotiated arrangements with one or more insurance carriers to provide life insurance which is sensitive to age, health and/or other typical life insurance variables, thereby giving the customer the more typical benefits of a life insurance type of policy. Should the customer desire help while reviewing the website enrollment module 24a, a link is also provided to the sales call center help desk, which help desk is also electronically connected to the insurance carrier E-platform such that the call center as well as the potential customer can be viewing the same information regarding the insurance contracts available so that the call center help desk can actually guide the customer through the insurance contract enrollment process.

In the alternative, once the customer learns of the insurance product/service provider or IP/SP at 23, the customer may directly contact the call center for information as shown at 26 and the call center, in cooperation with the call center help desk 26a can actually prepare the enrollment documents via computer for the potential customer. The call center can also provide the customer additional data with respect to insurance availability, and has its own computer network 17 (FIG. 1) which is coupled to the insurance carrier E-platform 25 to answer questions and guide the potential customer through the life insurance process.

Payment can either be by credit card as shown at 27 or by other selection shown at 28, which includes payment by check at 29. Upon payment either by credit card at 27 or by check at 29, the enrollment package may be completed in hard copy, if not already completed in an electronic form, which the customer then completes at 31 and mails in. Once payment is made either by credit card at 27 or by check at 29 with hard copy enrollment at 30, the insurance policy may be physically sent to the client, which step is shown at 32. Of course, other forms of payment, including payment according to a schedule, can also be arranged.

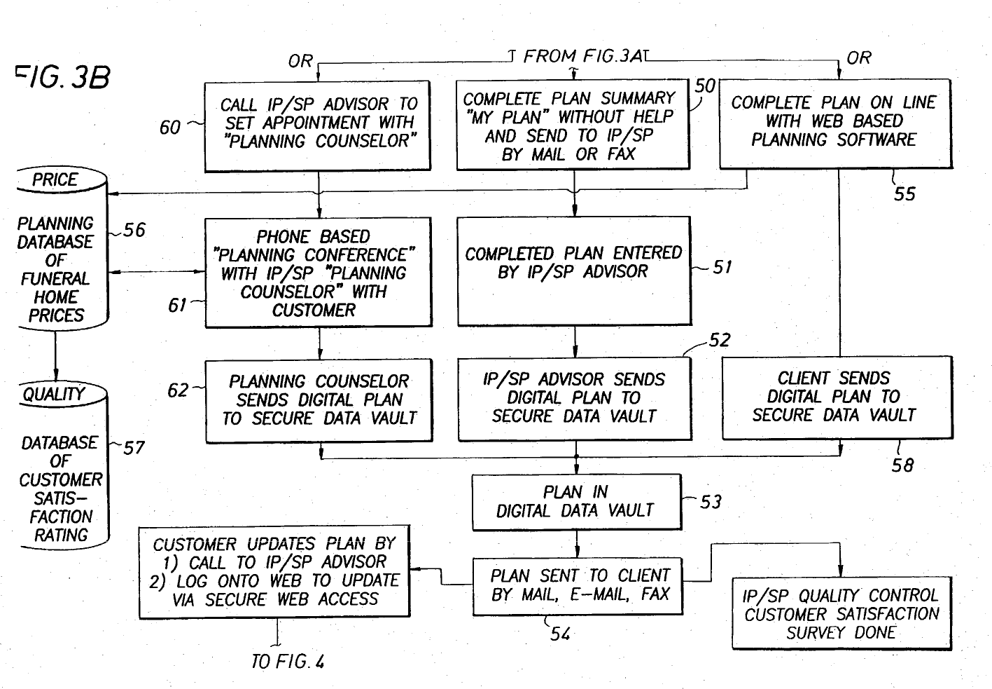

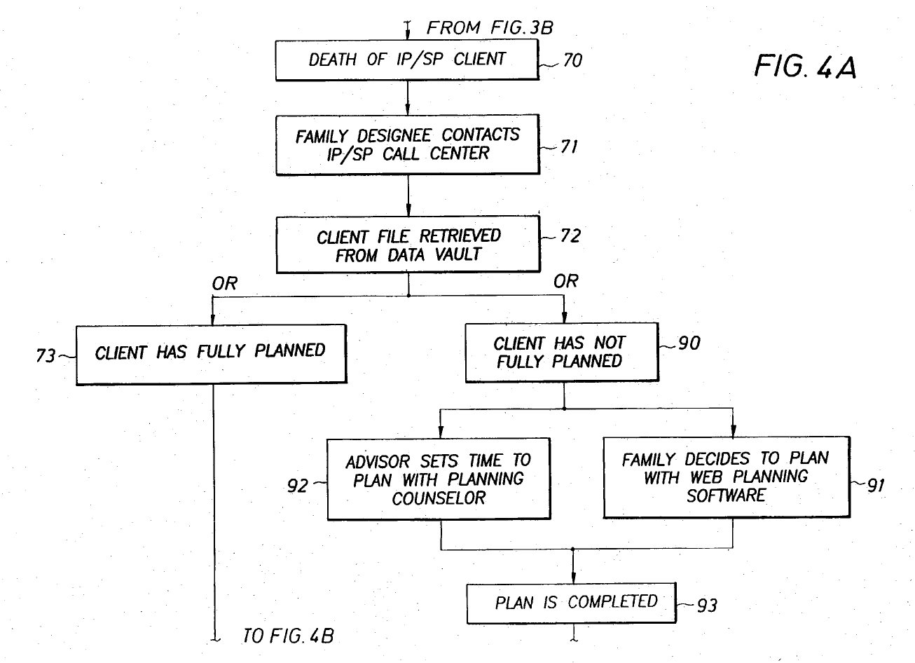

Referring now to FIGS. 3A and 3B, the central organization or IP/SP now enters into the funeral plan phase of the services provided on a continuous basis from consulting with the potential customer with respect to insurance funeral contracts through the actual time of need.

### Funeral Plan Enrollment Phase

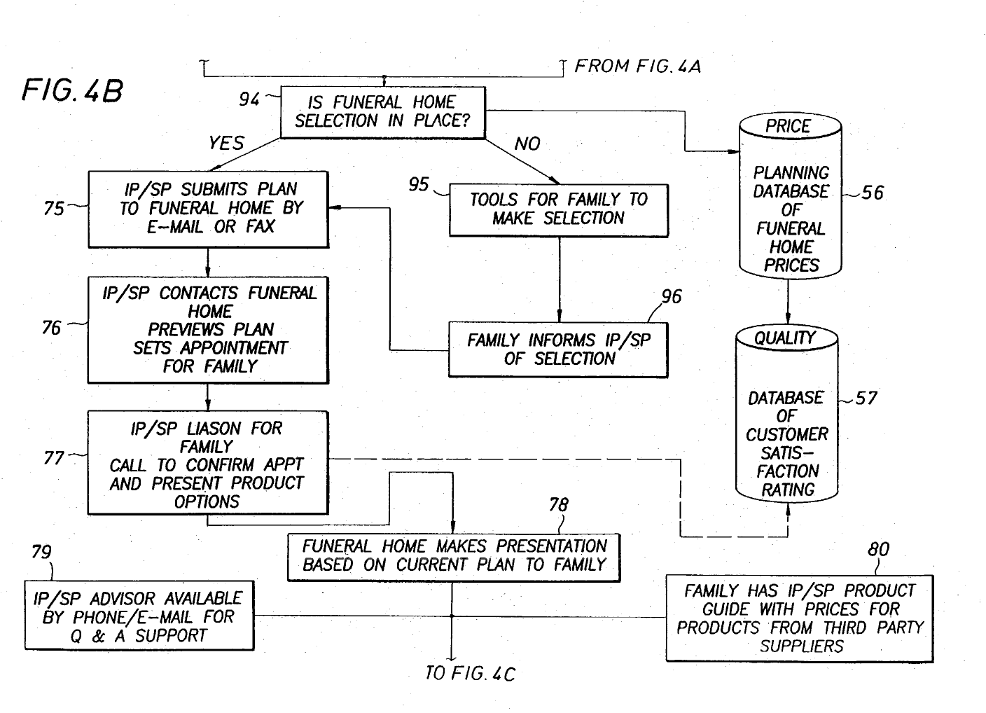

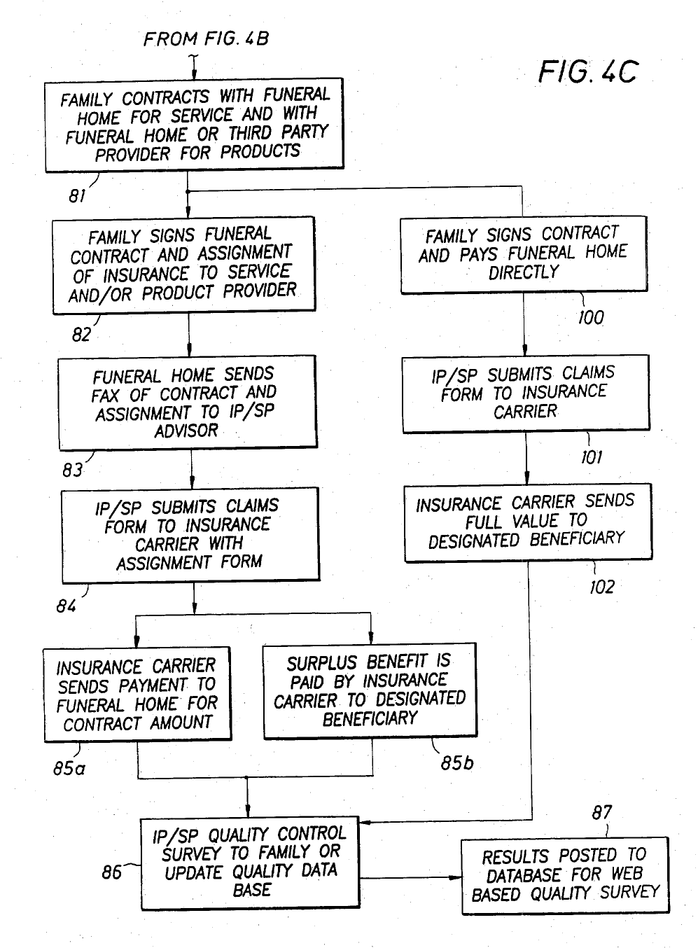

Referring in particular to FIG. 3A, the insurance carrier at 40 provides new customer notice electronically to the new customer or “customer member” and at the same time the insurance carrier provides electronic transfer of funds to the IP/SP, which is another advantage of this invention, that is, that the central organization or IP/SP is paid upfront and not at the time of the funeral. The IP/SP establishes a client or customer member file and the customer services group for the IP/SP makes direct contact with the new client/customer member at 42. The customer service network, including its call center, now enters into the funeral plan enrollment phase. First the IP/SP sends a proposed planning guide to the new client or customer member by mail, or electronically as shown at step 43, and additionally provides new client ID and password at step 44 to allow access by the client member to the services of the website or other internet access, as well as to the data vault 53 (FIG. 4). The customer services group through its call center in steps 45 and 46 consults with the client in order to help the client through the funeral planning process, which begins at step or stage 47.

Referring now to FIG. 3B, the actual planning of the funeral may take place by at least three different methods, among others. The client or customer member may, as shown in step or block 50 complete a plan summary without any aid from a planning counselor. Should the customer choose this route, the plan maybe completed even without access to pricing database 56. However, it should be understood that the funeral plan, though at least generally specific with respect to the nature of funeral products and service to be purchased at time of need, does not contain finalized pricing to apply at time of need. If the customer member or client completes the plan without aid, the plan is provided to an IP/SP advisor at 51 of the central service provider, who enters the plan digitally into a computer network 17 and electronically forwards the plan to the secure data vault 53, as illustrated at step 52 such that the plan enters the database of the digital data vault 53. The digital data vault 53 is coupled to the internet access or website 24 such that the client can review or revise his or her plan at any time by accessing the data vault through the internet using the client member ID and password previously provided in step 44. A copy of the plan is also forwarded electronically and/or by hard copy at step 54 to the client. A quality control survey 54a can be provided to the customer member at this time either in hard copy or electronically for forwarding to the survey database 57 in electronic form.

Referring again to FIG. 3B, in another alternative, a new customer member or client can complete the plan online using web-based software as illustrated at step 55. A planning database of funeral home prices, illustrated at 56, is electronically coupled to the website such that the customer has available competitive pricing relating to funeral merchandise available independent of any particular funeral home. It is contemplated that no final decisions as to price would be made during the funeral planning stage since the pricing will actually take place at the time of need, but the customer gets an excellent indication of available merchandise and pricing by accessing the price planning database at 56. In addition to a price planning database, there is also an electronic database 57, which includes customer satisfaction ratings and other survey information relating to prior customer satisfaction with products and services rendered, even by specific funeral homes. Both the quality database at 57 and the price planning database at 56 are electronically coupled to the web-based planning software on the website illustrated at 55. Utilizing the web-based planning software illustrated at 55 with the price planning database 56 and database of customer satisfaction 57, the new client or customer member can complete web-based funeral planning and send the complete or partially finalized digital plan to the secure data vault, as illustrated at step 58 such that the plan is stored and electronically accessible from the digital data vault 53.

Again referring to FIG. 3B, in another alternative, the new client may contact an IP/SP advisor to set an appointment with a planning counselor, which is among the services provided by the customer service center or call center as illustrated at step 60. Then, a phone based planning conference can take place between the planning counselor and the customer as illustrated at 61, with the planning counselor electronically accessing the planning database 56 and/or quality database of customer satisfaction ratings 57 in order to consult with the customer and guide the customer in making funeral planning choices. The IP/SP counselor creates a digital plan during this conference, which may be by phone or in person, and as shown at step 62, sends the digital plan to the secure data vault 53. Thereafter, the customer member may update the plan either by telephone communication with an IP/SP advisor or the customer member can log onto the website and obtain access to his or her plan in the digital data vault and make changes as desired or otherwise complete the funeral plan if not previously completed. While the customer may choose a funeral home as part of the funeral plan, the customer and even the customer's representatives, at time of need, can change the funeral home without financial penalty. In other words, the service provider will not profit from the choice of funeral home.

### Time of Need Phase

Referring now to FIGS. 4A, 4B and 4C, the time of need phase is entered with the advent of the death of the IP/SP client as illustrated at block 70. At the time of need, one or more family designees or representatives contacts the IP/SP service or call center, who retrieves the electronic funeral plan from the data vault at 72 in order to provide the funeral plan to the family representative or representatives either in hard copy or electronically. If the client fully planned the funeral, as illustrated at block 73, then all product and service choices had already been made except possibly for the funeral home. As shown in FIG. 4B, if the client has already selected the funeral home, then the IP/SP submits the finalized plan to the funeral home either electronically or by hard copy at 75. The IP/SP then contacts the funeral home and previews the finalized plan with the funeral home of choice and sets an appointment for the family at 76. The IP/SP thereafter acts as a continuous liaison for the family, consulting with the family in terms of finalization of the price of the planned funeral. In determining the final price, the family or other representative of the deceased has access to the electronic databases of competitive funeral home prices illustrated at 56 as well as the database of customer satisfaction 57, which was previously utilized by the customer in determining the funeral plan itself.

It is the purpose of the IP/SP to act as a liaison and consumer advocate independent of any particular funeral home. The IP/SP or service provider has no contractual arrangements with merchandise providers except to the extent that the IP/SP is able to establish favorable pricing or discounts for its customers. The IP/SP acts as a consumer advocate for the family representative to be certain that the interests of the family and the deceased are protected with respect to the finalization of the funeral plan, including making wise and value oriented choices with respect to the merchandise and services previously chosen by the deceased. Additionally, an IP/SP liaison arranges for the funeral home to make a presentation of its services based upon the current plan as shown at step 78. The IP/SP advisor may be available by phone or through electronic communication such as e-mail to provide support to the representative or family designee during the one or more meetings with the funeral home in order to provide objective advice with respect to any additional decisions that need to be made to finalize or revise the funeral plan, which availability is represented at block 79. Additionally, the family has available to it the IP/SP product guide either through a hard copy as illustrated at block 80 or the family can electronically access the competitive pricing database 56 as well as the customer satisfaction database 57 even during the meeting with the funeral home via internet access.

Referring now to FIG. 4C, with advice and consultation from the IP/SP or its call center, the family designee contracts with the funeral home as illustrated at 81 as well as with third party providers for products. The family representative then signs the funeral contract and makes assignment of insurance to the funeral home and product providers as illustrated at step 82, and the funeral home provides the contract and assignment back to the IP/SP advisor at 83, who then submits claim to the insurance carrier along with an assignment form as illustrated at 84. The insurance carrier then sends payment to the funeral home for the contract amount as illustrated at 85a or pays the funeral home and product service providers directly and provides any surplus benefit to the designated beneficiary as illustrated at 85b. Additionally, the IP/SP communicates with the family and family designee to obtain feedback through the quality control survey of products and services so that the quality database 57 can be updated, with the results being electronically posted to the database for availability to later customers and to the IP/SP as shown at 87.

Referring now back to FIG. 4A, if the client has not fully planned, as illustrated at block 90, the family designee has two choices available. The family designee can complete the funeral plan utilizing the web planning software as illustrated at step 91 (see FIG. 3B, block 55). In the alternative, an IP/SP planning counselor works with the family in finalizing the plan as shown at block 92, which plan is completed alternatively in steps 91 or 92 such that the completed plan is represented at block 93.

Referring now to FIG. 4B, if the funeral home was chosen, which condition is illustrated at block 94, then steps 75-87 follow. If a funeral home selection by the insured customer was not in place, then the family may make the selection through its own investigation or through consulting with the customer services group or IP/SP counselor. Block 95 refers to the tools available to the family to make a selection, including telephone communications with the IP/SP and a funeral planning counselor as just discussed, or additionally, the family may access the website or other net-worked computer site and utilize the information available within the web or network based funeral planning software, as illustrated at block 55 in FIG. 3B, to make a funeral home selection at 96. Once the funeral home selection is made and the IP/SP is informed, then the process proceeds through steps 75-87 as previously discussed.

Referring now to FIG. 4C, an alternate payment arrangement is also illustrated. Once the family contracts with the funeral home for services and with the funeral home or third party providers for products and specific funeral services, as represented within block 81, the family may sign a contract and pay the funeral home directly as illustrated in block 100. The IP/SP can also act as the claims agent and submit a claim either electronically or in hard copy to the insurance carrier as illustrated in step 101, which insurance carrier sends the full value to the designated beneficiary as illustrated at 102. Thereafter, since the funeral plan is now fully in place and ready to be implemented, the family designees or representatives are directed to the quality control survey 86, which may be provided to them in a hard copy or in an electronic form, such that the results are ultimately electronically posted within the database for web-based quality survey as illustrated at step 87.

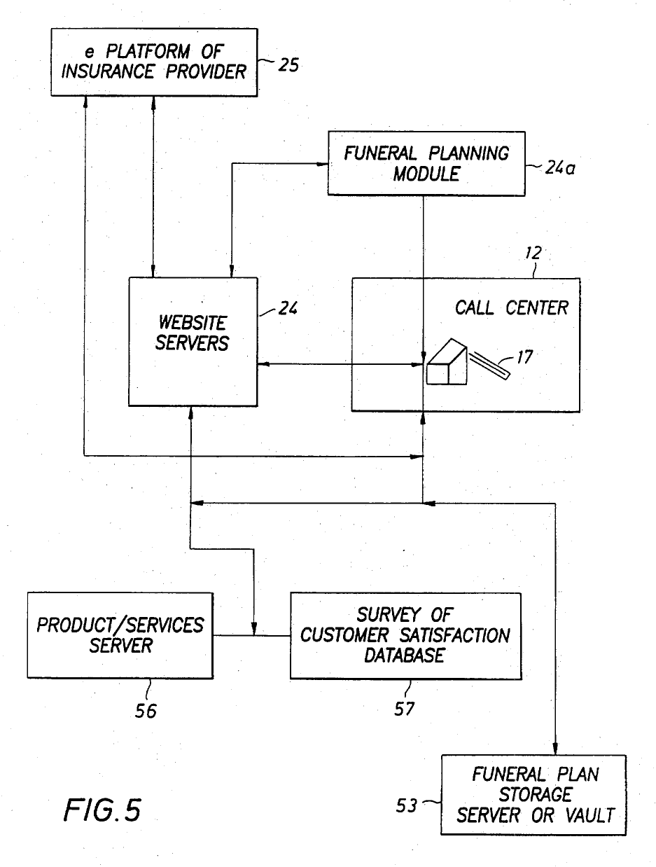

Referring to FIG. 5, the hardware and inter-connectivity of the computer systems of this invention are illustrated. The call center computer 17 is a network of computers within the call center 12 and includes the product/service pricing server 56, customer satisfaction database 57 and funeral plan storage database 53, which may be stored on a separate, net-worked computer or computer server. The funeral planning software 24a which is illustrated as available on the website 24 may also reside locally on the hardware of the network.

Whether the computers 17 are networked-based separate from the internet and website 24, or coupled to the internet, as is typical in computer systems today, all computer servers or drives operate under the control of operating systems to execute software such as necessary to operate the funeral planning software module 24a, or provide for organization, storage and retrieval within product pricing server 56. Instead of a server, the data vault may be a database stored in memory of one or more networked computers. For any additional storage, it is understood that a server may also include a storage interface to one or more mass storage devices, including but not limited to floppy or other removable disk drives, a hard disk drive or a direct access storage device, or an optical drive such as a CD drive or a DVD drive and/or tape drive, among others.

It is understood that the various servers and databases referred to herein may be implemented using off-the-shelf products to simplify design, with program code customized as necessary to support the functions described herein and that the program code may be implemented using various languages.

As illustrated in FIG. 5, the computer network 17 of the call center are coupled or otherwise networked to each of the components through any available hardwire or telecommunication connections such that there is full electronic or other data transmission.

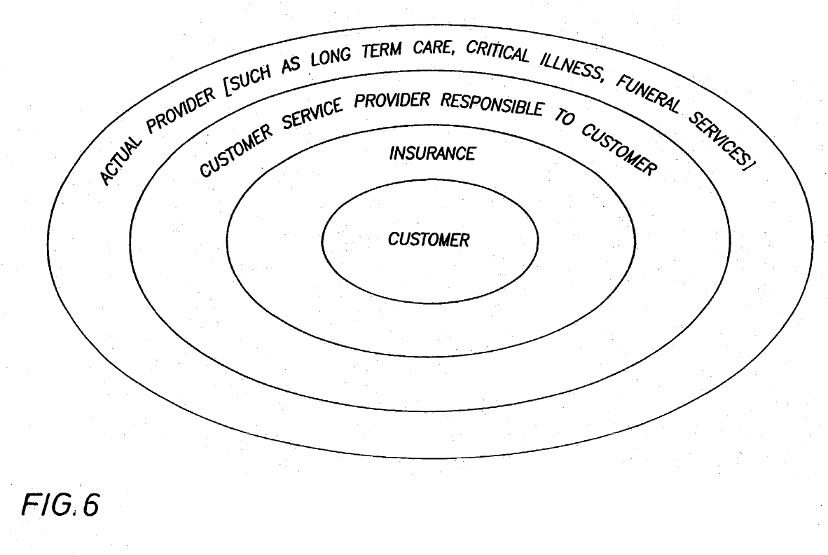

Referring now to FIG. 6, it should be understood that the combination package of insurance and continuous service available to the insured upon obtaining life insurance applies not only to the funeral planning industry but also to other industries where ultimately provided services are paid for by insurance. For example, long-term care and critical illness care are both often available to customers in the form of pre-need insurance. The central organization provider of this invention may make arrangements with such insurance providers for long-term care or critical illness care in a manner similar to the life insurance arrangements made as previously described. The customer services provider can then create the same service features and advantages of this invention within the framework and context of long-term care, critical illness care or other such insurance funded services wherein continuous services are provided from enrollment in an insurance plan through actual need. This invention is not limited, therefore, to the funeral industry and may extend to other industries where the same concepts may be utilized. Furthermore, this invention has identified a particular series of steps as illustrated in the various figures, and it should be understood that equivalent steps for each and every step within this invention come within the scope of this invention.

1. A method of providing life insurance and funeral services through the time of need, comprising the steps of:
providing a contract of life insurance from one or more insurance providers, said insurance being independent of any particular funeral home;
providing internet or other network access site to potential customers to respond to customer inquiries and enroll a customer into a contractual relationship with said insurance provider;
providing a customer services group to cooperate with a newly enrolled customer to prepare all or part of a funeral plan;
storing said funeral plan electronically until time of need;
providing for access to said stored funeral plan through said internet access to allow said customer to review and/or revise said funeral plan prior to time of need; and
at time of need, said customer services group providing said funeral plan to said customer's representatives and providing consumer-oriented product and service information to said representatives in order to finalize said funeral plan, including final choice of funeral home, and arrange implementation of said plan at the chosen funeral home.

2. The method of claim 1, further comprising the steps of:
providing said internet or other network access site with electronic access to a planning database containing competitive pricing for funeral home products.

3. The method of claim 1, further comprising the steps of:
providing said internet or other network access with electronic access to a database of customer satisfaction ratings of funeral products and services.

4. The method of claim 1, further comprising the steps of:
interconnecting said internet or other network access to an electronic database of life insurance information.

5. The method of claim 4, wherein,
said internet or other network access and electronic databases cooperate to provide a potential customer with enrollment information and electronic enrollment procedures.

6. The method of claim 1, further comprising the steps of:
said customer services group providing a concierge service to said customer and said customer's representative from the time of inquiry into life insurance availability through the time of need.

7. The method of claim 1, further comprising the steps of:
said life insurance having age and/or health-based pricing.

8. The method of claim 1, further comprising the steps of:
providing a call center available to said customer or customer representative from the time of interest in life insurance through the time of need.

9. The method of claim 1, further comprising the steps of
said internet or other network access having no contractual association with any particular funeral home to provide certain products or services of a particular funeral home.

10. The method of claim 1, further comprising the steps of:
said internet or other network access providing access to competitive funeral product and service pricing information located in an electronic database so that a customer has access to information needed to complete a funeral or revise a funeral plan.

11. The method of claim 1, further comprising the steps of:
said customer services group cooperating with a newly enrolled customer to assist in preparation of an electronic funeral plan and thereafter storing said plan in an electronic database.

12. The method set forth in claim 1, further comprising the steps of:
providing a customer satisfaction survey to said customer upon completion of said funeral plan.

13. The method set forth in claim 1, further comprising the steps of:
said customer services group making available to said customer representative a competitive pricing product and service database for revision or finalization of said funeral plan.

14. The method set forth in claim 1, including:
at the time of need, said customer services group arranging for said representatives to contract with the funeral home chosen as well as for products and services chosen, and arranging for insurance death benefits to be administered.

15. A method of providing a package of services and products of life insurance, funeral planning, and implementation at time of need, comprising:
creating a central organization to organize and supervise a combination of life insurance and customer services extending from signing of a life insurance contract through time of need;
providing a website to receive inquiries from potential customers;
electronically connecting said website to an electronic platform of one or more designated insurance carriers to provide potential customers with information on availability and pricing of life insurance;
providing an insurance policy upon payment arrangement being completed by a customer such that said customer becomes a customer member, said insurance carrier providing payment to said central organization upon funding by customer to insurance carrier;
providing said customer access to an electronic data base of funeral products containing competitive prices of funeral products;
said central organization including a customer services group for consulting with said customer to develop a funeral plan and electronically storing said funeral plan in a secure data vault until needed;
said customer services group retrieving said funeral plan from said secure data vault at time of need and providing said funeral plan to said customer's representatives;
said customer services group consulting with said representatives to complete funeral arrangements after review of funeral homes and competitive product pricing; and,
said customer services group arranging implementation of said finalized funeral plan with said funeral home on behalf of said representatives.

16. A business system for providing a package of life insurance and customer services which extend through finalization of funeral arrangements, comprising:
a central business entity having a contractual arrangement with one or more providers of life insurance;
said central business entity having a website for electronically answering potential customer inquiries;
said central business entity including a customer relations group coupled to said website to provide additional answers and clarification to a potential customer;
said website having an enrollment sequence for actual enrollment with insurance carrier on said website or an electronic connection to said one or more providers of life insurance providing for enrollment of customer into a life insurance contract;
said customer relations group maintaining communication with a customer who has obtained life insurance through the time of need;
said customer relations group communicating with said customer to arrive at a personalized funeral plan;
an electronic data vault to receive and store said personalized funeral plan;
said customer relations group being coupled to said data vault to recall said funeral plan upon need, and being coupled to a funeral product pricing and services database in order to consult with said customer's representatives to finalize and implement said funeral plan.

17. The system of claim 16, further including:
a competitive pricing database of funeral products and/or services, said database being electronically connected to said website.

18. The system of claim 16, further including:
an electronic database of customer survey results electronically connected to said website.

19. A method of providing life insurance and services through the time of need, comprising the steps of:
providing a contract of life insurance from one or more insurance providers, said insurance being independent of any particular funeral home;
providing internet access to customer inquiries and enrolling a customer into a contractual relationship with said insurance provider;
providing said internet access with a funeral planning software module to allow a customer to make desired choices of funeral products and services to arrive of a funeral plan;
storing said funeral plan electronically until time of need;
providing for access to said stored funeral plan through said internet access to allow said customer to review and/or revise said funeral plan prior to time of need; and
providing electronic access to said funeral plan by said customer's representatives and providing access to a consumer-oriented database of available funeral products and services in order for said representatives to finalize said funeral plan, including making final choice of funeral home and arranging implementation of said plan at the chosen funeral home.

20. The method of claim 19, further comprising the steps of:
providing said internet access with electronic access to a planning database containing competitive pricing for funeral home products.

21. The method of claim 20, further comprising the steps of:
providing said internet access with electronic access to a database of customer satisfaction ratings of funeral products and services.

22. The method of claim 19, further comprising the steps of
interconnecting said internet access to an electronic database of life insurance terms and conditions for inspection by a potential customer.

23. The method of claim 19 wherein,
said internet access and electronic database cooperating to provide a potential customer with life insurance enrollment information and electronic enrollment procedures.

24. A communication and software system for providing burial insurance and consultation services through the time of need, comprising:
a website accessible to general public;
said website being linked to one or more sources of funeral insurance carriers;
said website being in communication with a customer service group for providing electronic information regarding a new customer who has become insured by one of said linked funeral insurance carriers; and
said website being further linked to a data base for funeral plans, said funeral plan data base being accessible by said customer service group, and by customers who have funeral plans in said database.

25. The system of claim 24, further including:
said website being linked to a funeral product database containing pricing for various manufactures of funeral products.

26. The system of claim 24, further including:
said website being electronically connected to an electronic platform or website of one or more insurance carriers to provide potential customers with information on availability and pricing of life insurance.
